(19) United States
(12) Patent Application Publication
(10) Pub. No.: US 2018/0056454 A1
(43) Pub. Date: Mar. 1, 2018

(54) FLUX-CORED WIRE FOR GAS SHIELDED ARC WELDING

(71) Applicant: NIPPON STEEL & SUMIKIN WELDING CO., LTD., Tokyo (JP)

(72) Inventors: Yuki KAYAMORI, Tokyo (JP); Kiyohito SASAKI, Tokyo (JP); Yasuhito TOTSUKA, Tokyo (JP); Naoki SAKABAYASHI, Tokyo (JP)

(73) Assignee: NIPPON STEEL & SUMIKIN WELDING CO., LTD., Tokyo (JP)

(21) Appl. No.: 15/641,616

(22) Filed: Jul. 5, 2017

(30) Foreign Application Priority Data
Aug. 29, 2016 (JP) 2016-167212

(51) Int. Cl. B23K 35/32; B23K 35/362

(52) U.S. Cl. CPC B23K 35/325; B23K 35/362

(57) ABSTRACT

A flux-cored wire for gas shielded arc welding includes C: 0.03 to 0.09%, Si: 0.1 to 0.6%, Mn: 1.3 to 3.0%, Ti: 0.05 to 0.50%, B: 0.002 to 0.015%, and Al₂O₃ converted value: 0.4 to 1.0%, as the total content in the steel sheath and the flux in mass % relative to the total mass of the wire; and TiO₂ converted value: 5.0 to 9.0%, SiO₂ converted value: 0.2 to 0.7%, ZrO₂ converted value: 0.1 to 0.6%, Mg: 0.2 to 0.8%, total of F converted value: 0.02 to 0.20%, and total of Na₂O converted value and K₂O converted value: 0.03 to 0.20%; as a content in the flux; in which a content of C in the steel sheath is 0.03% or less in mass % relative to the total mass of the steel sheath.

### BACKGROUND

### Technical Field

The present invention relates to a flux-cored wire for gas shielded arc welding that is used for welding in a steel structure of mild steel to 490 MPa class high tensile strength steel, low temperature steel, or the like, and specifically to a flux-cored wire for gas shielded arc welding, which is favorable for welding workability in all-position welding, generates a less amount of spatters, and further is suitable for obtaining a weld metal having excellent low-temperature toughness, even in a case where either a carbon dioxide gas or an Ar—CO₂ mixed gas is used for the shield gas.

### Related Art

The gas shielded arc welding using a flux-cored wire is highly efficient and excellent in welding workability, therefore, is widely used for constructing various welded structures such as shipbuilding, bridges, marine structures, and steel frames. In recent years, there is a demand for development of a flux-cored wire, with which the stable toughness of a weld metal is obtained even under a low temperature environment of around −40° C., and further the spatter generation amount is small and the welding workability is excellent.

The flux-cored wire used for gas shielded arc welding is classified into a metal type flux-cored wire and a slag type flux-cored wire, and the slag-based flux-cored wire includes a rutile type flux-cored wire and a basic type flux-cored wire.

The basic type flux-cored wire has a small oxygen content in the weld metal, therefore, is excellent in low-temperature toughness of the weld metal, but on the contrary, is significantly inferior in the welding workability, which is the arc stability, the bead shape, and the like, as compared with the rutile type flux-cored wire, therefore, is rarely used in general.

On the other hand, the rutile type flux-cored wire is extremely excellent in the welding workability in all-position welding, therefore, is widely used in the fields of shipbuilding, steel frames, marine structures, and the like. However, the rutile type flux-cored wire contains a large amount of metal oxides mainly including TiO₂, therefore, in a case of performing the welding under the low temperature environment as described above, there is a problem that the low-temperature toughness required for the weld metal is inferior.

For the rutile type flux-cored wire used under a low temperature environment, various developments have been made so far. For example, in JP 9-262693 A, a flux-cored wire, with which favorable welding workability and excellent low-temperature toughness of the weld metal can be obtained by defining the contents of TiO₂, Mg, B, Ti, Mn, K, Na, and Si in the flux-cored wire, has been disclosed, however, there is no definition for metal oxides other than TiO₂, the arc stability, the slag encapsulation, and the resistance to metal-sagging are poor, and thus sufficient welding workability cannot be obtained.

Further, in JP 6-238483 A, a flux-cored wire, with which favorable welding workability and excellent low-temperature toughness of the weld metal can be obtained by defining the contents of one kind or two or more kinds of TiO₂, SiO₂, Si, Mn, Mg, B, Al, Ca, Ni, Ti, and Zr in the flux-cored wire, has been disclosed. According to the technique disclosed in JP 6-238483 A, the welding workability, which is the bead shape, the slag encapsulation, and the like, is improved by the addition of an adequate amount of TiO₂ and SiO₂, and the low-temperature toughness of the weld metal can be improved by a synergistic effect of Ca, Al, Ti, and B, however, the arc stability, and the slag removability are poor, and thus sufficient welding workability cannot be obtained.

In addition, in recent years, for the purpose of improving mechanical properties of the weld metal, a mixed gas mainly containing Ar is used for the shield gas instead of a carbon dioxide gas. In JP 2015-80811 A, a flux-cored wire, with which favorable welding workability and excellent low-temperature toughness of the weld metal can be obtained by using an Ar—CO₂ mixed gas for the shield gas, by defining the contents of C, Si, Mn, Cu, Ni, Ti, B, TiO₂, Al₂O₃, SiO₂, ZrO₂, Mg, Na₂O, K₂O, fluorine compounds, and the like in the flux-cored wire, and further by defining the total content of hydrogen in the flux-cored wire, has been disclosed. According to the technique disclosed in JP 2015-80811 A, by the addition of an adequate amount of metal oxides such as TiO₂, Al₂O₃, SiO₂, ZrO₂, Mg, Na₂O, and K₂O, favorable welding workability, which is excellent bead shape, excellent slag removability, excellent arc stability, and the like, is obtained, and further by the addition of an adequate amount of C, Si, Mn, Cu, Ni, Ti, and B, the low-temperature toughness of the weld metal can be improved. However, in a case of using an Ar—CO₂ mixed gas for the shield gas, there is a problem that as compared with the case of using a carbon dioxide gas, the arc easily becomes unstable, the spatter generation amount is increased and many sputters adhere to the steel sheet surface in the vicinity of the weld bead, and the work efficiency is poor.

Further, in actual welding sites, from the viewpoint of the high efficiency of the welding operation, a flux-cored wire, with which favorable welding workability and excellent low-temperature toughness of the weld metal can be obtained even by using either an Ar—CO₂ mixed gas or a carbon dioxide gas, is strongly demanded. However, in a case where the gas shielded arc welding is performed with the flux-cored wire for gas shielded arc welding described in JP 2015-80811 A by using a carbon dioxide gas, there is a problem that the arc easily becomes unstable and the spatter generation amount is increased, and further sufficient mechanical properties of the weld metal cannot be obtained.

### SUMMARY

Accordingly, the present invention is made in consideration of the problems described above, and an object of the present invention is to provide a flux-cored wire for gas shielded arc welding, with which even in a case where either a carbon dioxide gas or an Ar—CO₂ mixed gas is used for the shield gas in welding a steel structure of mild steel to 490 MPa class high tensile strength steel, low temperature steel, or the like, the welding workability in all-position welding is favorable, the spatter generation amount is small, and further a weld metal having excellent low-temperature toughness can be obtained.

The present inventors made various studies on the flux-cored wire for gas shielded arc welding using a carbon dioxide gas or an Ar—CO₂ mixed gas as the shield gas, in order to obtain favorable welding workability, which is favorable arc stability in all-position welding, a less amount of spatters, and the like, and further to obtain a weld metal having favorable low-temperature toughness.

As a result, the present inventors have found that when the yield of each component to the weld metal in the flux-cored wire in gas shielded arc welding using a carbon dioxide gas or an Ar—CO₂ mixed gas for the shield gas is compared, the oxygen content in the shield gas is more decreased in the gas shielded arc welding using an Ar—CO₂ mixed gas, therefore, the yield of C, Si, Mn or the like to the weld metal becomes higher, and there is a difference in the mechanical performances of the weld metals.

Accordingly, as a result of the various studies to obtain the sufficient strength and excellent low-temperature toughness of the weld metal even in a case where either a carbon dioxide gas or an Ar—CO₂ mixed gas is used, the present inventors have found that while ensuring the sufficient strength of the weld metal by the addition of an adequate amount of C, and Mn in the flux-cored wire, the low-temperature toughness of the weld metal can be improved by the addition of an adequate amount of Ti, and B, and in particular, in a case of also using an Ar—CO₂ mixed gas, the sufficient low-temperature toughness can be obtained by further adjusting Si, and Mn. Further, the present inventors have also found that the low-temperature toughness of the weld metal can further be improved by the addition of an adequate amount of Ni.

In addition, with regard to the welding workability, even in a case where either a carbon dioxide gas or an Ar—CO₂ mixed gas is used, as a result of adjusting the flux-cored wire component with which the arc stability is favorable and the spatter generation amount is small, the present inventors have found that by defining the content of C in the steel sheath of the flux-cored wire, and further by the addition of an adequate amount of Ti oxides into the flux-cored wire, the arc stability is improved, and further the spatter generation amount can be reduced by making the droplets finer in size. Further, the present inventors have found that by the addition of an adequate amount of Na and K compounds, the arc stability is improved in a case of using a carbon dioxide gas, and further the concentration of an arc can be improved in a case of using an Ar—CO₂ mixed gas.

Furthermore, the present inventors have found that by the addition of an adequate amount of Ti oxides, Si oxides, Zr oxides, Al and Al oxides, Mg, and fluorine compounds into the flux-cored wire, the bead shape, the slag encapsulation, the slag removability, and the resistance to metal-sagging are improved, and the favorable welding workability can be achieved. Moreover, the present inventors have also found that by the addition of an adequate amount of Bi, the slag removability can further be improved.

That is, the gist of the present invention lies in a flux-cored wire for gas shielded arc welding with a flux filled in a steel sheath of the flux-cored wire, including: C: 0.03 to 0.09%, Si: 0.1 to 0.6%, Mn: 1.3 to 3.0%, Ti: 0.05 to 0.50%, B: 0.002 to 0.015%, and total of Al₂O₃ converted value of Al and Al₂O₃ converted value of Al oxides: 0.4 to 1.0%, as the total content in the steel sheath and the flux in mass % relative to the total mass of the wire; total TiO₂ converted value of Ti oxides: 5.0 to 9.0%, total SiO₂ converted value of Si oxides: 0.2 to 0.7%, total ZrO₂ converted value of Zr oxides: 0.1 to 0.6%, Mg: 0.2 to 0.8%, total F converted value of fluorine compounds: 0.02 to 0.20%, and total of Na₂O converted value and K₂O converted value of Na compounds and K compounds: 0.03 to 0.20%, as a content in the flux in mass % relative to the total mass of the wire; and a balance of Fe of the steel sheath, iron powder, a Fe component of iron alloy powder, and unavoidable impurities, wherein a content of C in the steel sheath is 0.03% or less in mass % relative to the total mass of the steel sheath.

In addition, the gist of the present invention lies in the flux-cored wire for gas shielded arc welding, further including: Ni: 0.1 to 0.6% as the total content in the steel sheath and the flux in mass % relative to the total mass of the wire.

Furthermore, the gist of the present invention lies in the flux-cored wire for gas shielded arc welding, further including: Bi: 0.005 to 0.020% as a content in the flux in mass % relative to the total mass of the wire.

According to the flux-cored wire for gas shielded arc welding to which the present invention is applied, even in a case where either a carbon dioxide gas or an Ar—CO₂ mixed gas is used for the shield gas in welding a steel structure of mild steel to 490 MPa class high tensile strength steel, low temperature steel, or the like, the welding workability in all-position welding is favorable, the spatter generation amount can be reduced, and further a weld metal having excellent low-temperature toughness can be obtained, therefore, the improvement of the welding efficiency and the improvement of the quality of the welded part can be achieved.

### DETAILED DESCRIPTION

Hereinafter, component composition and each content in the steel sheath of the flux-cored wire for gas shielded arc welding to which the present invention is applied, and the reason for the limitation of each component composition will be described. Note that the content of the component composition is expressed in mass o, and the mass % is expressed simply by % when being expressed.
[C in the steel sheath: 0.03% or less in mass % relative to the total mass of the steel sheath]

C in the steel sheath has an effect of suppressing the burst phenomenon of the droplets at the time of welding, stabilizing the arc, and reducing the spatter generation amount. Further, the C makes the droplets finer, therefore, the spatters adhering to the steel sheet surface in the vicinity of the weld bead are largely decreased. In addition, the arc becomes soft, therefore, there is also an effect that excessive digging of the molten pool is reduced in the vertical upward welding, and the resistance to metal-sagging is improved and the bead shape becomes favorable. When the C in the steel sheath exceeds 0.03%, the arc becomes excessively sharp, and the spatter generation amount is increased. Further, when the C in the steel sheath exceeds 0.03%, the metal-sagging is easily generated in the vertical upward welding, and the bead shape becomes poor. Therefore, the C in the steel sheath is 0.03% or less in mass % relative to the total mass of the steel sheath.

Hereinafter, the content of each component composition is expressed in mass % relative to the total mass of the flux-cored wire.
[C as the total content in the steel sheath and the flux: 0.03 to 0.09%]

C has an effect of improving the strength of the weld metal. When the C is less than 0.03%, the sufficient strength cannot be obtained in the weld metal. On the other hand, when the C exceeds 0.09%, the yield of C to the weld metal becomes excessive, and the strength becomes excessively high and the low-temperature toughness is decreased in the weld metal. Therefore, the C as the total content in the steel sheath and the flux is 0.03 to 0.09%. Note that to the C, C from the metal powder, alloy powder, and the like in the flux in addition to the components contained in the steel sheath can be added.
[Si as the total content in the steel sheath and the flux: 0.1 to 0.6%]

Si acts as a deoxidizer, and has an effect of improving the low-temperature toughness of the weld metal. When the Si is less than 0.1%, the effect cannot be obtained, the yield of Si to the weld metal is not sufficiently obtained in the carbon dioxide gas shielded arc welding, and the low-temperature toughness of the weld metal is decreased. On the other hand, when the Si exceeds 0.6%, the yield of Si to the weld metal becomes excessive, and on the contrary, the low-temperature toughness of the weld metal is decreased. Therefore, the Si as the total content in the steel sheath and the flux is 0.1 to 0.6%. Note that to the Si, Si from the metal Si, and alloy powder of Fe—Si, Fe—Si—Mn, and the like in the flux in addition to the components contained in the steel sheath can be added.
[Mn as the total content in the steel sheath and the flux: 1.3 to 3.0%]

Mn acts as a deoxidizer, and further has an effect of improving the strength and low-temperature toughness of the weld metal while remaining in the weld metal. When the Mn is less than 1.3%, the yield of Mn to the weld metal is not sufficiently obtained in the carbon dioxide gas shielded arc welding, and the low-temperature toughness of the weld metal is decreased, and further the sufficient strength cannot be obtained. On the other hand, when the Mn exceeds 3.0%, the yield of Mn to the weld metal becomes excessive, and the strength becomes high and the low-temperature toughness is decreased in the weld metal. Therefore, the Mn as the total content in the steel sheath and the flux is 1.3 to 3.0%. Note that to the Mn, Mn from the metal Mn, and alloy powder of Fe—Mn, Fe—Si—Mn, and the like in the flux in addition to the components contained in the steel sheath can be added.
[Ti as the total content in the steel sheath and the flux: 0.05 to 0.50%]

Ti refines the structure of the weld metal and has an effect of improving the low-temperature toughness. When the Ti is less than 0.05%, the effect cannot be sufficiently obtained, and the low-temperature toughness of the weld metal is decreased. On the other hand, when the Ti exceeds 0.50%, an upper bainite structure that inhibits toughness is generated, and the low-temperature toughness of the weld metal is decreased. Therefore, the Ti as the total content in the steel sheath and the flux is 0.05 to 0.50%. Note that to the Ti, Ti from the metal Ti, and alloy powder of Fe—Ti, and the like in the flux in addition to the components contained in the steel sheath can be added.
[B as the total content in the steel sheath and the flux: 0.002 to 0.015%]

B refines the microstructure of the weld metal by the addition of a minute amount of B and has an effect of improving the low-temperature toughness of the weld metal. When the B is less than 0.002%, the effect cannot be sufficiently obtained, and the low-temperature toughness of the weld metal is decreased. On the other hand, when the B exceeds 0.015%, hot cracks are easily generated. Therefore, the B as the total content in the steel sheath and the flux is 0.002 to 0.015%. Note that to the B, B from the metal B, and alloy powder of Fe—B, Fe—Mn—B, and the like in the flux in addition to the components contained in the steel sheath can be added.
[Total of Al₂O₃ converted value of Al and Al₂O₃ converted value of Al oxides as the total content in the steel sheath and the flux: 0.4 to 1.0%]

Al and Al oxides adjust the melting point and viscosity of the molten slag, and particularly have an effect of improving the resistance to metal-sagging and the bead shape in the vertical upward welding. When the total of Al₂O₃ converted value of Al and Al₂O₃ converted value of Al oxides is less than 0.4%, the effect cannot be sufficiently obtained, and the metal-sagging is easily generated in the vertical upward welding, and the bead shape becomes poor. On the other hand, when the total of Al₂O₃ converted value of Al and Al₂O₃ converted value of Al oxides exceeds 1.0%, Al excessively remains as Al oxides in the weld metal, and the low-temperature toughness of the weld metal is decreased. Therefore, the total of Al₂O₃ converted value of Al and Al₂O₃ converted value of Al oxides as the total content in the steel sheath and the flux is 0.4 to 1.0%. Note that to the Al, Al from the metal Al, and alloy powder of Fe—Al, and the like in the flux in addition to the components contained in the steel sheath can be added, and to the Al oxides, Al oxides from the alumina, and the like in the flux can be added.
[Total TiO₂ converted value of Ti oxides in the flux: 5.0 to 9.0%]

Ti oxides improve the arc stability, and further adjust the melting point and viscosity of the molten slag at the time of welding, and have an effect of improving the resistance to metal-sagging, the slag removability, and the bead shape. When the total TiO₂ converted value of Ti oxides is less than 5.0%, these effects cannot be sufficiently obtained, the arc becomes unstable and the spatter generation amount is increased, and the spatters adhere in a large amount to the steel sheet surface in the vicinity of the weld bead. Further, the metal-sagging is easily generated in the vertical upward welding and the vertical downward welding. Furthermore, the slag generation amount is decreased, therefore, the slag encapsulation, the slag removability, and the bead shape become poor in each welding position. Moreover, in the horizontal fillet welding, the slag generated in the lower end side of the weld bead cannot be supported, and the bead shape becomes in an overlap state. On the other hand, when the total TiO₂ converted value of Ti oxides exceeds 9.0%, the slag generation amount is extremely increased, and a weld defect such as slag inclusion is easily generated in the welded part in each position welding. In addition, Ti oxides excessively remain in the weld metal, and the low-temperature toughness of the weld metal is decreased. Therefore, the total TiO₂ converted value of Ti oxides in the flux is 5.0 to 9.0%. Note that to the Ti oxides, Ti oxides from the rutile, titanium oxides, titanium slag, ilmenite, and the like in the flux are be added.
[Total SiO₂ converted value of Si oxides in the flux: 0.2 to 0.7%]

Si oxides adjust the viscosity and melting point of the molten slag at the time of welding, and have an effect of improving the slag encapsulation. When the total SiO₂ converted value of Si oxides is less than 0.2%, the effect cannot be sufficiently obtained, and the slag encapsulation is deteriorated and the bead appearance becomes poor in each welding position. On the other hand, when the total SiO₂ converted value of Si oxides exceeds 0.7%, Si oxides excessively remain in the weld metal, and further the basicity of the molten slag is decreased and the oxygen content in the weld metal is increased, and the low-temperature toughness of the weld metal is decreased. Therefore, the total SiO₂ converted value of Si oxides in the flux is 0.2 to 0.7%. Note that to the Si oxides, Si oxides from the silica sand, potassium feldspar, zircon sand, sodium silicate, and the like in the flux can be added.
[Total ZrO₂ converted value of Zr oxides in the flux: 0.1 to 0.6%]

Zr oxides adjust the viscosity and melting point of the molten slag at the time of welding, and particularly have an effect of improving the resistance to metal-sagging and the bead shape in the vertical upward welding. When the ZrO₂ converted value of Zr oxides is less than 0.1%, the effect cannot be sufficiently obtained, and the metal-sagging is easily generated in the vertical upward welding, and the bead shape becomes poor. On the other hand, when the ZrO₂ converted value of Zr oxides exceeds 0.6%, the slag removability becomes poor in each welding position. Therefore, the total ZrO₂ converted value of Zr oxides in the flux is 0.1 to 0.6%. Note that to the Zr oxides, Zr oxides from the zircon sand, zirconium oxides, and the like in the flux can be added, and further a minute amount of Zr oxides is contained in Ti oxides.
[Mg in the flux: 0.2 to 0.8%]

Mg acts as a strong deoxidizer and decreases the oxygen in the weld metal, and has an effect of improving the low-temperature toughness of the weld metal. When the Mg is less than 0.2%, the effect cannot be sufficiently obtained, the insufficient deoxidation is caused, and the low-temperature toughness of the weld metal is decreased. On the other hand, when the Mg exceeds 0.8%, Mg reacts vigorously with oxygen in the arc at the time of welding and the arc becomes unstable, and the spatter generation amount is increased and many sputters adhere to the steel sheet surface in the vicinity of the weld bead. Therefore, the Mg in the flux is 0.2 to 0.8%. Note that to the Mg, Mg from the metal Mg, and alloy powder of Al—Mg, and the like in the flux can be added.
[Total F converted value of fluorine compounds in the flux: 0.02 to 0.20%]

Fluorine compounds strengthen the arc, and further particularly have an effect of improving the resistance to metal-sagging and the bead shape in the vertical upward welding and the vertical downward welding. When the total F converted value of fluorine compounds is less than 0.02%, the effect cannot be sufficiently obtained, the arc becomes weak, the metal-sagging is easily generated in the vertical upward welding and the vertical downward welding, and the bead shape becomes poor. On the other hand, when the total F converted value of fluorine compounds exceeds 0.20%, the arc becomes extremely strong, the metal-sagging is easily generated in the vertical upward welding, and the bead shape becomes poor. Therefore, the total F converted value of fluorine compounds in the flux is 0.02 to 0.20%. Note that to the fluorine compounds, fluorine compounds from CaF₂, NaF, LiF, MgF₂, K₂SiF₆, Na₃AlF₆, AlF₃, and the like can be added, and the F converted value is the total value of the F content contained in those compounds.
[Total of Na₂O converted value and K₂O converted value of Na compounds and K compounds in the flux: 0.03 to 0.20%]

Na compounds and K compounds act as an arc stabilizer, and have an effect of improving the arc stability in a case of using a carbon dioxide gas and the concentration of an arc in a case of using an Ar—CO₂ mixed gas. When the total of Na₂O converted value and K₂O converted value of Na compounds and K compounds is less than 0.03%, the arc becomes unstable in the carbon dioxide gas shielded arc welding, and the spatter generation amount is increased. On the other hand, when the total of Na₂O converted value and K₂O converted value of Na compounds and K compounds exceeds 0.20%, the arc extremely concentrates in the Ar—CO₂ mixed gas shielded arc welding, the arc length becomes longer and unstable, and the spatter generation amount is increased. Further, the metal-sagging is easily generated in the vertical upward welding and the vertical downward welding, and the bead shape becomes poor. Therefore, the total of Na₂O converted value and K₂O converted value of Na compounds and K compounds in the flux is 0.03 to 0.20%. Note that to the Na compounds and K compounds, Na compounds and K compounds from a solid component of water glass made of sodium silicate and potassium silicate, sodium fluoride, sodium titanate, potassium silicofluoride, sodium silicofluoride, and the like can be added.
[Ni as the total content in the steel sheath and the flux: 0.1 to 0.6%]

Ni has an effect of further improving the low-temperature toughness of the weld metal. When the Ni is less than 0.1%, the effect of further improving the low-temperature toughness of the weld metal cannot be sufficiently obtained. On the other hand, when the Ni exceeds 0.6%, there may be a case where the tensile strength of the weld metal becomes excessively high, and hot cracks are easily generated. Therefore, the Ni as the total content in the steel sheath and the flux is 0.1 to 0.6%. Note that to the Ni, Ni from the metal Ni, and alloy powder of Fe—Ni, and the like in the flux in addition to the components contained in the steel sheath can be added.
[Bi as the total content in the steel sheath and the flux: 0.005 to 0.020%]

Bi has an effect of promoting the removing of the slag from the weld metal, and further improving the slag removability. When the Bi is less than 0.005%, the effect cannot be sufficiently obtained, and there may be a case where the sufficient slag removability cannot be obtained in all-position welding. On the other hand, when the Bi exceeds 0.020%, the low-temperature toughness of the weld metal is decreased, and further hot cracks are easily generated. Therefore, the Bi as the total content in the steel sheath and the flux is 0.005 to 0.020%. Note that to the Bi, Bi from alloy powder of metal Bi, and the like in the flux can be added.

The balance of the flux-cored wire for gas shielded arc welding of the present invention is Fe of the steel sheath, iron powder to be added, a Fe component of iron alloy powder of Fe—Mn, Fe—Si and the like, and unavoidable impurities. Further, in order to adjust the components, FeO, MnO or the like may be added. The unavoidable impurities are not particularly limited, but from the viewpoint of the resistance to hot cracks, it is preferred that P is 0.020% or less and S is 0.010% or less.

As the shield gas of the gas shielded arc welding of the present invention, either a carbon dioxide gas or an Ar—CO₂ mixed gas can be used. Further, in a case of an Ar—CO₂ mixed gas, from the viewpoint of reducing the oxygen content of the weld metal, it is preferred that Ar is mainly used and the proportion of CO₂ is 20 to 25%.

In addition, the flux-cored wire for gas shielded arc welding of the present invention has a structure in which the steel sheath is formed in a pipe shape and the flux is filled inside the steel sheath, and roughly classified into a seamless type flux-cored wire obtained by welding the seam of the steel sheath, and a seam type flux-cored wire obtained by caulking but not welding the seam of the steel sheath. With the seamless type flux-cored wire, a heat treatment for the purpose of reducing the hydrogen content in the flux-cored wire can be performed, and further since the absorbing moisture of the flux-cored wire after the production is small, the diffusible hydrogen of the weld metal can be reduced, and the improvement of the crack resistance can be achieved, therefore, this is more preferred.

Further, the flux filling rate is not particularly limited, however, from the viewpoint of the productivity, preferably 8 to 20% relative to the total mass of the wire.

### EXAMPLES

Hereinafter, effects of the present invention will be described by way of Examples.

Using JIS G 3141 SPCC of various kinds of component compositions shown in Table 1 for the steel sheath, the steel sheath was formed into a U shape, and into the U-shaped steel sheath, flux was filled with a filling rate of 10 to 15%, and the steel sheath was formed into a C shape, and then the seam of the steel sheath was welded to make a tube and the tube was drawn. Flux-cored wires having various kinds of components shown in Table 2 were prototyped. Further, the diameter of the prototyped wires was set to be 1.2 mm.

TABLE 1

| | |
|---|---|
| Steel | |
| sheath | Chemical component (mass %) |

| symbol | C | Si | Mn | P | S | Al |
|---|---|---|---|---|---|---|
| S1 | 0.028 | 0.01 | 0.25 | 0.011 | 0.005 | 0.03 |
| S2 | 0.015 | 0.01 | 0.41 | 0.015 | 0.006 | 0.04 |
| S3 | 0.005 | 0.01 | 0.33 | 0.017 | 0.007 | 0.03 |
| S4 | 0.042 | 0.01 | 0.27 | 0.012 | 0.005 | 0.03 |

TABLE 2

| | | | Flux-cored wire component (mass % relative to the total mass of flux-cored wire) | | | | | | | | | |
|---|---|---|---|---|---|---|---|---|---|---|---|---|
| | | | | | | | | (a) Al₂O₃ | (b) Al₂O₃ | | | |
| | | | | | | | | converted | converted | | TiO₂ | SiO₂ |
| | Wire | Steel sheath | | | | | | value of | value of | | converted | converted |
| Category | symbol | symbol | C | Si | Mn | Ti | B | Al | Al oxides | (a) + (b) | value | value |
| The present | W1 | S2 | 0.053 | 0.53 | 2.73 | 0.31 | 0.0077 | 0.32 | 0.53 | 0.85 | 6.53 | 0.53 |
| invention | W2 | S3 | 0.071 | 0.34 | 1.73 | 0.45 | 0.0113 | 0.25 | 0.29 | 0.54 | 8.27 | 0.61 |
| | W3 | S1 | 0.084 | 0.57 | 2.55 | 0.22 | 0.0054 | 0.15 | 0.72 | 0.87 | 6.15 | 0.32 |
| | W4 | S2 | 0.056 | 0.47 | 2.43 | 0.12 | 0.0072 | 0.21 | 0.32 | 0.53 | 6.15 | 0.46 |
| | W5 | S2 | 0.035 | 0.55 | 1.80 | 0.43 | 0.0090 | 0.25 | 0.45 | 0.70 | 5.92 | 0.64 |
| | W6 | S3 | 0.063 | 0.23 | 2.86 | 0.20 | 0.0130 | 0.32 | 0.30 | 0.62 | 6.83 | 0.59 |
| | W7 | S2 | 0.039 | 0.32 | 2.29 | 0.15 | 0.0077 | 0.25 | 0.36 | 0.61 | 6.25 | 0.55 |
| | W8 | S3 | 0.032 | 0.13 | 1.33 | 0.05 | 0.0023 | 0.21 | 0.76 | 0.97 | 5.06 | 0.67 |
| | W9 | S2 | 0.071 | 0.31 | 2.35 | 0.23 | 0.0070 | 0.30 | 0.43 | 0.73 | 7.55 | 0.37 |
| | W10 | S2 | 0.042 | 0.13 | 1.60 | 0.16 | 0.0140 | 0.26 | 0.24 | 0.50 | 7.92 | 0.50 |
| | W11 | S1 | 0.088 | 0.24 | 2.40 | 0.08 | 0.0080 | 0.30 | 0.12 | 0.42 | 8.97 | 0.37 |
| | W12 | S2 | 0.032 | 0.57 | 2.98 | 0.48 | 0.0148 | 0.17 | 0.31 | 0.48 | 6.12 | 0.22 |
| Comparative | W13 | S4 | 0.083 | 0.04 | 2.83 | 0.37 | 0.0064 | 0.25 | 0.37 | 0.62 | 5.92 | 0.51 |
| Example | W14 | S3 | 0.023 | 0.50 | 1.69 | 0.20 | 0.0033 | 0.12 | 0.44 | 0.56 | 6.25 | 0.58 |
| | W15 | S2 | 0.098 | 0.36 | 2.44 | 0.23 | 0.0137 | 0.17 | 0.26 | 0.43 | 4.82 | 0.61 |
| | W16 | S3 | 0.071 | 0.71 | 2.30 | 0.14 | 0.0115 | 0.32 | 0.34 | 0.66 | 7.83 | 0.13 |
| | W17 | S2 | 0.042 | 0.28 | 1.23 | 0.42 | 0.0060 | 0.34 | 0.20 | 0.54 | 8.28 | 0.28 |
| | W18 | S2 | 0.063 | 0.37 | 2.22 | 0.32 | 0.0111 | 0.21 | 0.24 | 0.45 | 7.88 | 0.81 |
| | W19 | S2 | 0.055 | 0.22 | 3.09 | 0.20 | 0.0048 | 0.28 | 0.41 | 0.69 | 5.82 | 0.39 |
| | W20 | S2 | 0.047 | 0.53 | 2.10 | 0.04 | 0.0057 | 0.21 | 0.20 | 0.41 | 8.63 | 0.42 |
| | W21 | S3 | 0.081 | 0.29 | 2.64 | 0.61 | 0.0122 | 0.17 | 0.16 | 0.33 | 8.16 | 0.49 |
| | W22 | S2 | 0.078 | 0.18 | 1.40 | 0.26 | 0.0012 | 0.25 | 0.15 | 0.40 | 6.82 | 0.60 |
| | W23 | S2 | 0.059 | 0.32 | 1.90 | 0.45 | 0.0162 | 0.28 | 0.37 | 0.65 | 7.25 | 0.59 |
| | W24 | S2 | 0.073 | 0.45 | 2.23 | 0.49 | 0.0146 | 0.21 | 0.23 | 0.44 | 9.11 | 0.34 |
| | W25 | S2 | 0.060 | 0.60 | 2.47 | 0.22 | 0.0063 | 0.53 | 0.57 | 1.10 | 5.83 | 0.50 |
| | W26 | S2 | 0.036 | 0.38 | 1.82 | 0.15 | 0.0070 | 0.21 | 0.11 | 0.32 | 6.83 | 0.57 |
| | W27 | S2 | 0.060 | 0.24 | 2.36 | 0.09 | 0.0095 | 0.25 | 0.22 | 0.47 | 7.25 | 0.51 |

| | | Flux-cored wire component (mass % relative to the total mass of flux-cored wire) | | | | | | | | |
|---|---|---|---|---|---|---|---|---|---|---|
| | | ZrO₂ | | F | (c) Na₂O | (d) K₂O | | | | |
| | Wire | converted | | converted | converted | converted | | | | |
| Category | symbol | value | Mg | value | value | value | (c) + (d) | Ni | Bi | Others* |
| The present | W1 | 0.31 | 0.33 | 0.13 | 0.083 | 0.054 | 0.137 | — | — | Balance |
| invention | W2 | 0.20 | 0.64 | 0.08 | 0.051 | 0.043 | 0.094 | — | — | Balance |
| | W3 | 0.42 | 0.70 | 0.16 | 0.072 | 0.032 | 0.104 | — | — | Balance |
| | W4 | 0.42 | 0.42 | 0.08 | 0.052 | 0.052 | 0.104 | 0.32 | 0.0154 | Balance |
| | W5 | 0.57 | 0.47 | 0.08 | 0.080 | 0.011 | 0.091 | 0.53 | — | Balance |
| | W6 | 0.33 | 0.52 | 0.14 | 0.037 | 0.058 | 0.095 | — | 0.0115 | Balance |
| | W7 | 0.38 | 0.37 | 0.09 | 0.056 | 0.067 | 0.123 | 0.29 | 0.0149 | Balance |
| | W8 | 0.58 | 0.45 | 0.02 | 0.113 | 0.085 | 0.198 | 0.43 | 0.0197 | Balance |
| | W9 | 0.21 | 0.63 | 0.16 | 0.101 | 0.070 | 0.171 | — | 0.0170 | Balance |
| | W10 | 0.17 | 0.20 | 0.11 | 0.052 | 0.063 | 0.115 | 0.32 | — | Balance |
| | W11 | 0.40 | 0.21 | 0.15 | 0.075 | 0.021 | 0.096 | 0.11 | 0.0181 | Balance |
| | W12 | 0.13 | 0.77 | 0.18 | 0.025 | 0.008 | 0.033 | 0.58 | 0.0052 | Balance |
| Comparative | W13 | 0.67 | 0.51 | 0.06 | 0.085 | 0.058 | 0.143 | — | — | Balance |
| Example | W14 | 0.36 | 0.13 | 0.08 | 0.123 | 0.008 | 0.131 | — | — | Balance |
| | W15 | 0.42 | 0.38 | 0.12 | 0.085 | 0.033 | 0.118 | 0.25 | 0.0043 | Balance |
| | W16 | 0.37 | 0.88 | 0.15 | 0.115 | 0.055 | 0.170 | 0.33 | 0.0071 | Balance |
| | W17 | 0.25 | 0.42 | 0.01 | 0.058 | 0.012 | 0.070 | — | — | Balance |
| | W18 | 0.32 | 0.61 | 0.16 | 0.055 | 0.053 | 0.108 | 0.28 | — | Balance |
| | W19 | 0.51 | 0.55 | 0.28 | 0.089 | 0.013 | 0.102 | 0.24 | 0.0154 | Balance |
| | W20 | 0.03 | 0.23 | 0.06 | 0.039 | 0.044 | 0.083 | 0.04 | 0.0116 | Balance |
| | W21 | 0.30 | 0.41 | 0.18 | 0.057 | 0.066 | 0.123 | 0.51 | 0.0140 | Balance |
| | W22 | 0.26 | 0.57 | 0.07 | 0.170 | 0.110 | 0.280 | — | 0.0075 | Balance |
| | W23 | 0.52 | 0.63 | 0.13 | 0.015 | 0.008 | 0.023 | — | — | Balance |
| | W24 | 0.45 | 0.35 | 0.04 | 0.114 | 0.068 | 0.182 | 0.42 | 0.0101 | Balance |
| | W25 | 0.33 | 0.53 | 0.07 | 0.110 | 0.033 | 0.143 | 0.26 | — | Balance |
| | W26 | 0.45 | 0.61 | 0.15 | 0.038 | 0.022 | 0.060 | 0.69 | 0.0061 | Balance |
| | W27 | 0.04 | 0.75 | 0.05 | 0.115 | 0.037 | 0.152 | 0.42 | 0.0211 | Balance |

*Others are FeO, MnO, Fe of the steel sheath, iron powder, a Fe component in iron alloy powder, and unavoidable impurities

By using the prototyped wires, the welding workability in the vertical upward welding, the vertical downward welding, or the horizontal fillet welding, and the mechanical properties of the weld metal were investigated.

For the welding workability, on each test specimen of a SM490B steel sheet in accordance with JIS G 3106 with a thickness of 16 mm assembled in a T shape, vertical upward welding, vertical downward welding, and horizontal fillet welding were performed under the welding conditions shown in Tables 3 and 4, at that time, the arc state, the spatter generation state, the slag encapsulation, the slag removability, the quality of the bead shape, the presence or absence of the metal-sagging were investigated by visual inspection. In addition, the fracture surface was confirmed in accordance with JIS Z 3181, and the presence or absence of a weld defect such as slag inclusion was investigated.

TABLE 3

| | | | Welding | Arc | Welding | |
|---|---|---|---|---|---|---|
| | Groove | Welding | current | voltage | speed | Shield |
| Test item | shape | position | (A) | (V) | (cm/min) | gas |
| Evaluation of | T shape | Vertical | 180-220 | 20-23 | 10-20 | CO₂ |
| welding | fillet | upward | 160-200 | 22-25 | 6-12 | Ar—CO₂ |
| workability | | Vertical | 250-270 | 25-30 | 60-80 | CO₂ |
| | | downward | 230-250 | 27-31 | 35-45 | Ar—CO₂ |
| | | Horizontal | 260-280 | 29-31 | 50-70 | CO₂ |
| | | fillet | 240-240 | 31-33 | 30-40 | Ar—CO₂ |
| Weld metal | In | Flat | 270 | 27 | 30 | CO₂ |
| test | accordance | | | 29 | | Ar—CO₂ |
| | with JIS Z | | | | | |
| | 3111 | | | | | |

TABLE 4

| | | | | Welding workability | | | | |
|---|---|---|---|---|---|---|---|---|
| | | | | | | Vertical upward | | |
| | | | | | | | | Presence |
| | | | | | | | | or |
| | | | | | Spatter | | | absence |
| | Test | Wire | | Arc | generation | Slag | Slag | of metal- |
| Category | symbol | symbol | Shield gas | stability | amount | removability | encapsulation | sagging |
| The present | T1 | W1 | CO₂ | Stable | Small | Good | Good | Absent |
| invention | T2 | W2 | A-20% CO₂ | Stable | Small | Good | Good | Absent |
| | T3 | W3 | A-20% CO₂ | Stable | Small | Good | Good | Absent |
| | T4 | W4 | CO₂ | Stable | Small | Good | Good | Absent |
| | T5 | W5 | CO₂ | Stable | Small | Good | Good | Absent |
| | T6 | W4 | A-20% CO₂ | Stable | Small | Good | Good | Absent |
| | T7 | W6 | CO₂ | Stable | Small | Good | Good | Absent |
| | T8 | W7 | A-20% CO₂ | Stable | Small | Good | Good | Absent |
| | T9 | W8 | CO₂ | Stable | Small | Good | Good | Absent |
| | T10 | W7 | CO₂ | Stable | Small | Good | Good | Absent |
| | T11 | W9 | CO₂ | Stable | Small | Good | Good | Absent |
| | T12 | W10 | A-20% CO₂ | Stable | Small | Good | Good | Absent |
| | T13 | W11 | CO₂ | Stable | Small | Good | Good | Absent |
| | T14 | W12 | CO₂ | Stable | Small | Good | Good | Absent |
| Comparative | T15 | W13 | CO₂ | Strong | Large | Poor | Good | Present |
| Example | T16 | W14 | CO₂ | Stable | Small | Good | Good | Absent |
| | T17 | W15 | CO₂ | Unstable | Large | Poor | Poor | Poor |
| | T18 | W16 | A-20% CO₂ | Unstable | Large | Good | Poor | Absent |
| | T19 | W17 | CO₂ | Weak | Small | Good | Good | Present |
| | T20 | W18 | A-20% CO₂ | Stable | Small | Good | Good | Absent |
| | T21 | W19 | A-20% CO₂ | Strong | Small | Good | Good | Present |
| | T22 | W20 | CO₂ | Stable | Small | Good | Good | Present |
| | T23 | W21 | A-20% CO₂ | Stable | Small | Good | Good | Present |
| | T24 | W22 | A-20% CO₂ | Unstable | Large | Good | Good | Present |
| | T25 | W23 | A-20% CO₂ | Unstable | Large | Good | Good | Absent |
| | T26 | W24 | CO₂ | Stable | Small | Good | Good | Absent |
| | T27 | W25 | CO₂ | Stable | Small | Good | Good | Absent |
| | T28 | W26 | A-20% CO₂ | Stable | Small | Good | Good | Present |
| | T29 | W27 | CO₂ | Stable | Small | Good | Good | Present |

| | | Welding workability | | | | | | |
|---|---|---|---|---|---|---|---|---|
| | | | | Vertical downward | | | | |
| | | | | | | Presence | | |
| | | | | | | or | | |
| | | Vertical upward | | | | absence | | |
| | Test | Bead | Weld | Slag | Slag | of metal- | Bead | Weld |
| Category | symbol | shape | defect | removability | encapsulation | sagging | shape | defect |
| The present | T1 | Good | Absent | Good | Good | Absent | Good | Absent |
| invention | T2 | Good | Absent | Good | Good | Absent | Good | Absent |
| | T3 | Good | Absent | Good | Good | Absent | Good | Absent |
| | T4 | Good | Absent | Good | Good | Absent | Good | Absent |
| | T5 | Good | Absent | Good | Good | Absent | Good | Absent |
| | T6 | Good | Absent | Good | Good | Absent | Good | Absent |
| | T7 | Good | Absent | Good | Good | Absent | Good | Absent |
| | T8 | Good | Absent | Good | Good | Absent | Good | Absent |
| | T9 | Good | Absent | Good | Good | Absent | Good | Absent |
| | T10 | Good | Absent | Good | Good | Absent | Good | Absent |
| | T11 | Good | Absent | Good | Good | Absent | Good | Absent |
| | T12 | Good | Absent | Good | Good | Absent | Good | Absent |
| | T13 | Good | Absent | Good | Good | Absent | Good | Absent |
| | T14 | Good | Absent | Good | Good | Absent | Good | Absent |
| Comparative | T15 | Poor | Absent | Poor | Good | Absent | Good | Absent |
| Example | T16 | Good | Absent | Good | Good | Absent | Good | Absent |
| | T17 | Poor | Absent | Poor | Poor | Poor | Poor | Absent |
| | T18 | Poor | Absent | Good | Poor | Absent | Poor | Absent |
| | T19 | Poor | Absent | Good | Good | Present | Poor | Absent |
| | T20 | Good | Absent | Good | Good | Absent | Good | Absent |
| | T21 | Poor | Absent | Good | Good | Absent | Good | Absent |
| | T22 | Poor | Absent | Good | Good | Absent | Good | Absent |
| | T23 | Poor | Absent | Good | Good | Absent | Good | Absent |
| | T24 | Poor | Absent | Good | Good | Present | Poor | Absent |
| | T25 | Good | Absent | Good | Good | Absent | Good | Absent |
| | T26 | Good | Slag | Good | Good | Absent | Good | Slag |
| | | | inclusion | | | | | inclusion |
| | T27 | Good | Absent | Good | Good | Absent | Good | Absent |
| | T28 | Poor | Absent | Good | Good | Absent | Good | Absent |
| | T29 | Poor | Absent | Good | Good | Absent | Good | Absent |

| | | | | | | Weld metal | | |
|---|---|---|---|---|---|---|---|---|
| | | | | | | Presence | | |
| | | Welding workability | | | | or | | |
| | | Horizontal fillet | | | | absence | | |
| | Test | Slag | Slag | Bead | Weld | of hot | TS | vE-40 |
| Category | symbol | removability | encapsulation | shape | defect | cracks | (MPa) | (J) |
| The present | T1 | Good | Good | Good | Absent | Absent | 590 | 63 |
| invention | T2 | Good | Good | Good | Absent | Absent | 620 | 65 |
| | T3 | Good | Good | Good | Absent | Absent | 666 | 53 |
| | T4 | Good | Good | Good | Absent | Absent | 576 | 81 |
| | T5 | Good | Good | Good | Absent | Absent | 536 | 84 |
| | T6 | Good | Good | Good | Absent | Absent | 602 | 72 |
| | T7 | Good | Good | Good | Absent | Absent | 603 | 55 |
| | T8 | Good | Good | Good | Absent | Absent | 618 | 73 |
| | T9 | Good | Good | Good | Absent | Absent | 516 | 89 |
| | T10 | Good | Good | Good | Absent | Absent | 556 | 79 |
| | T11 | Good | Good | Good | Absent | Absent | 576 | 62 |
| | T12 | Good | Good | Good | Absent | Absent | 585 | 80 |
| | T13 | Good | Good | Good | Absent | Absent | 605 | 75 |
| | T14 | Good | Good | Good | Absent | Absent | 618 | 71 |
| Comparative | T15 | None | Good | Good | Absent | Absent | 614 | 42 |
| Example | T16 | Good | Good | Good | Absent | Absent | 479 | 40 |
| | T17 | None | None | None | Absent | Absent | 693 | 23 |
| | T18 | None | Good | None | Absent | Absent | 641 | 28 |
| | T19 | Good | Good | Good | Absent | Absent | 485 | 42 |
| | T20 | Good | Good | Good | Absent | Absent | 656 | 36 |
| | T21 | Good | Good | Good | Absent | Absent | 720 | 23 |
| | T22 | Good | Good | Good | Absent | Absent | 555 | 46 |
| | T23 | Good | Good | Good | Absent | Absent | 651 | 32 |
| | T24 | Good | Good | Good | Absent | Absent | 604 | 37 |
| | T25 | Good | Good | Good | Absent | Present | 613 | 68 |
| | T26 | Good | Good | Good | Slag | Absent | 624 | 34 |
| | | | | | inclusion | | | |
| | T27 | Good | Good | Good | Absent | Absent | 631 | 36 |
| | T28 | Good | Good | Good | Absent | Present | 681 | 49 |
| | T29 | Good | Good | Good | Absent | Present | 635 | 28 |

In the weld metal test, by using a SM490B steel sheet in accordance with JIS G 3106 with a thickness of 20 mm, welding was performed in accordance with JIS Z 3111, tensile test pieces (No. A0) and impact test pieces (V-notch test pieces) were taken from the center in the thickness direction of the weld metal, and mechanical tests were performed on the test pieces. In the evaluation of the tensile tests, tensile strength of 490 to 670 MPa was evaluated as good. In the evaluation of the impact tests, a Charpy impact test at −40° C. was performed, and the average value of repeated three measurements of absorption energy of 47 J or more was evaluated as good. At that time, the presence or absence of hot cracks in the initial layer welding was investigated by visual inspection. These results are summarized and shown in Table 4.

In all of the wire symbols W1 to W12 in Table 2, which are examples of the present invention, the component compositions are all within the ranges defined in the present invention, and in all of the wire symbols W13 to W27, which are comparative examples, any one or more of the component compositions are deviated from the ranges defined in the present invention. Test symbols T1 to T14 in Table 4 were investigated and tested by using wires of wire symbols W1 to W12 as the examples of the present invention, and test symbols T15 to T29 were investigated and tested by using wires of wire symbols W13 to W27 as the comparative examples. In test symbols T1 to T14 that are examples of the present invention, C in the steel sheath, C as the total content in the steel sheath and flux of the flux-cored wire, Si, Mn, Ti, B, the total of Al₂O₃ converted value of Al and Al₂O₃ converted value of Al oxides, the total TiO₂ converted value of Ti oxides in the flux, the total SiO₂ converted value of Si oxides, the total ZrO₂ converted value of Zr oxides, Mg, the total F converted value of fluorine compounds, and the total of Na₂O converted value and K₂O converted value of Na compounds and K compounds were appropriate, therefore, in either a carbon dioxide gas or an Ar—CO₂ mixed gas, the arc was stable and the spatter generation amount was small, there was no metal-sagging in the vertical upward welding and the vertical downward welding, the slag encapsulation, the slag removability, and the bead shape were favorable in each position welding, there was no weld defect such as slag inclusion and the welding workability was favorable, and hot cracks were not generated. Further, the tensile strength and the absorption energy of the weld metal were also favorable.

In addition, in test symbols T4 to T6, T8 to T10, and T12 to T14, since wires of wire symbols W4 to W5, W7 to W8, and W10 to W12 with the addition of an adequate amount of Ni were used, 70 J or more of the absorption energy of the weld metal was obtained. Further, in test symbols T4, T6 to T11, T13, and T14, since wires of wire symbols W4, W6 to W9, and W11 to W12 with the addition of an adequate amount of Bi were used, the slag removability was extremely favorable.

In test symbol T15 in comparative examples, since C in the steel sheath was large, the arc became extremely strong, and the spatter generation amount was large. Further, the metal-sagging was generated in the vertical upward welding, and the bead shape was poor. Furthermore, since Si was small, the absorption energy of the weld metal in the carbon dioxide gas shielded arc welding was low. Moreover, since the total ZrO₂ converted value of Zr oxides was large, the slag removability was poor in all-position welding.

In test symbol T16, since C as the total content in the steel sheath and the flux was small, the tensile strength of the weld metal was low. Further, since Mg was small, the absorption energy of the weld metal was low.

In test symbol T17, since C as the total content in the steel sheath and the flux was large, the tensile strength of the weld metal was high and the absorption energy of the weld metal was low. Further, since the total TiO₂ converted value of Ti oxides was small, the arc was unstable, and the spatter generation amount was large. Furthermore, the metal-sagging was generated in the vertical upward welding and the vertical downward welding, and the slag encapsulation, the slag removability, and the bead shape were poor in all-position welding. Moreover, since the addition amount of Bi was small, an improvement effect of the slag removability was not obtained.

In test symbol T18, since Si was large, the absorption energy of the weld metal was low. Further, since the total SiO₂ converted value of Si oxides was small, the slag encapsulation, and the bead shape were poor in all-position welding. Furthermore, since Mg was large, the arc was unstable, and the spatter generation amount was large.

In test symbol T19, since Mn was small, the tensile strength and the absorption energy of the weld metal in the carbon dioxide gas shielded arc welding were low. Further, since the total F converted value of fluorine compounds was small, the arc was weak, the metal-sagging was generated in the vertical upward welding and the vertical downward welding, and the bead shape was poor.

In test symbol T20, since the total SiO₂ converted value of Si oxides was large, the absorption energy of the weld metal was low.

In test symbol T21, since Mn was large, the tensile strength of the weld metal was high and the absorption energy of the weld metal was low. Further, since the total F converted value of fluorine compounds was large, the arc was extremely strong, the metal-sagging was generated in the vertical upward welding, and the bead shape was poor.

In test symbol T22, since Ti was small, the absorption energy of the weld metal was low. Further, since the total ZrO₂ converted value of Zr oxides was small, the metal-sagging was generated in the vertical upward welding, and the bead shape was poor. Furthermore, since the addition amount of Ni was small, an effect of improving the absorption energy of the weld metal was not obtained.

In test symbol T23, since Ti was large, the absorption energy of the weld metal was low. Further, since the total of Al₂O₃ converted value of Al and Al₂O₃ converted value of Al oxides was small, the metal-sagging was generated in the vertical upward welding, and the bead shape was poor.

In test symbol T24, since B was small, the absorption energy of the weld metal was low. Further, since the total of Na₂O converted value and K₂O converted value of Na compounds and K compounds was large, the arc became unstable in the Ar—CO₂ mixed gas shielded arc welding, and the spatter generation amount was large. Furthermore, the metal-sagging was generated in the vertical upward welding and the vertical downward welding, and the bead shape was poor.

In test symbol T25, since B was large, hot cracks were generated in the welded part. Further, since the total of Na₂O converted value and K₂O converted value of Na compounds and K compounds was small, the arc became unstable in the carbon dioxide gas shielded arc welding, and the spatter generation amount was large.

In test symbol T26, since the total TiO₂ converted value of Ti oxides was large, the absorption energy of the weld metal was low. Further, the slag inclusion was generated in the welded part in all-position welding.

In test symbol T27, the total of Al₂O₃ converted value of Al and Al₂O₃ converted value of Al oxides was large, the absorption energy of the weld metal was low.

In test symbol T28, since the total of Al₂O₃ converted value of Al and Al₂O₃ converted value of Al oxides was small, the metal-sagging was generated in the vertical upward welding, and the bead shape was poor. Further, since Ni was high, the tensile strength of the weld metal was high, and hot cracks were generated in the welded part.

In test symbol T29, since the total ZrO₂ converted value of Zr oxides was small, the metal-sagging was generated in the vertical upward welding, and the bead shape was poor. Further, since Bi was high, the absorption energy of the weld metal was low, and hot cracks were generated in the welded part.

What is claimed is:

1. A flux-cored wire for gas shielded arc welding with a flux filled in a steel sheath of the flux-cored wire, comprising of:
C: 0.03 to 0.09%,
Si: 0.1 to 0.6%,
Mn: 1.3 to 3.0%,
Ti: 0.05 to 0.50%,
B: 0.002 to 0.015%, and
total of Al₂O₃ converted value of Al and Al₂O₃ converted value of Al oxides: 0.4 to 1.0%, as the total content in the steel sheath and the flux in mass % relative to the total mass of the wire;
total TiO₂ converted value of Ti oxides: 5.0 to 9.0%,
total SiO₂ converted value of Si oxides: 0.2 to 0.7%,
total ZrO₂ converted value of Zr oxides: 0.1 to 0.6%,
Mg: 0.2 to 0.8%,
total F converted value of fluorine compounds: 0.02 to 0.20%, and
total of Na₂O converted value and K₂O converted value of Na compounds and K compounds: 0.03 to 0.20%, as a content in the flux in mass % relative to the total mass of the wire; and
a balance of Fe of the steel sheath, iron powder, a Fe component of iron alloy powder, and unavoidable impurities,
wherein a content of C in the steel sheath is 0.03% or less in mass % relative to the total mass of the steel sheath.

2. The flux-cored wire for gas shielded arc welding according to claim 1, further comprising of:
Ni: 0.1 to 0.6%
as the total content in the steel sheath and the flux in mass % relative to the total mass of the wire.

3. The flux-cored wire for gas shielded arc welding according to claim 1, further comprising of:
Bi: 0.005 to 0.020%
as a content in the flux in mass % relative to the total mass of the wire.

4. The flux-cored wire for gas shielded arc welding according to claim 2, further comprising of:
Bi: 0.005 to 0.020%
as a content in the flux in mass % relative to the total mass of the wire.
